(19) United States
(12) Patent Application Publication
(10) Pub. No.: US 2026/0339805 A1
(43) Pub. Date: Oct. 29, 2026

(54) AUTOMATIC AGENT METRIC GENERATION

(71) Applicant: Cisco Technology, Inc., San Jose, CA (US)

(72) Inventors: Andrea Morandi, Greenbrae, CA (US); Saurabh Gupta, Bellevue, WA (US); Mahesh Viswanathan, White Plains, NY (US)

(73) Assignee: Cisco Technology, Inc., San Jose, CA (US)

(21) Appl. No.: 19/191,224

(22) Filed: Apr. 28, 2025

(51) Int. Cl. G06F 11/34; G06F 11/3668

(52) U.S. Cl. CPC G06F 11/3414; G06F 11/3668

(57) ABSTRACT

In one implementation, a device that executes a metrics agent obtains a description of a use case for an agentic system that comprises one or more artificial intelligence-based agents. The device retrieves example rubrics based on the description of the use case. The device generates a set of rubrics and performance metrics by inputting the description of the use case and the example rubrics to the metrics agent. The device provides the set of rubrics and performance metrics to test how well the agentic system performs for the use case.

### TECHNICAL FIELD

The present disclosure relates generally to artificial intelligence and, more particularly, to automatic agent metric generation.

### BACKGROUND

The recent breakthroughs in artificial intelligence (AI) such as large language models (LLMs) represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs.

Indeed, current AI-based agents demonstrate impressive problem-solving capabilities through multi-step reasoning and research. However, evaluating their performance of a given agent, or the set of agents as a whole, remains challenging. This is because different tasks can have very different goals and measures of success. Consequently, the evaluation criteria to evaluate the performance of a set of agents when performing a given task is manually crafted today, which is time-consuming and may not capture the specific nuances of the task.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIG. 5 illustrates an example architecture for automatic agent metric generation;

FIGS. 6A-6B illustrate an example of automatically generating rubrics to evaluate an AI agent;

FIG. 7 illustrates an example prompt for the metric agent in FIG. 5;

FIGS. 8A-8B illustrate an example of the automatic generation of prompts based on the description of rubrics; and

FIG. 9 illustrates an example simplified procedure for automatic agent metric generation, in accordance with one or more implementations described herein.

### DESCRIPTION OF EXAMPLE IMPLEMENTATIONS

### Overview

According to one or more implementations of the disclosure, a device that executes a metrics agent obtains a description of a use case for an agentic system that comprises one or more artificial intelligence-based agents. The device retrieves example rubrics based on the description of the use case. The device generates a set of rubrics and performance metrics by inputting the description of the use case and the example rubrics to the metrics agent. The device provides the set of rubrics and performance metrics to test how well the agentic system performs for the use case.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

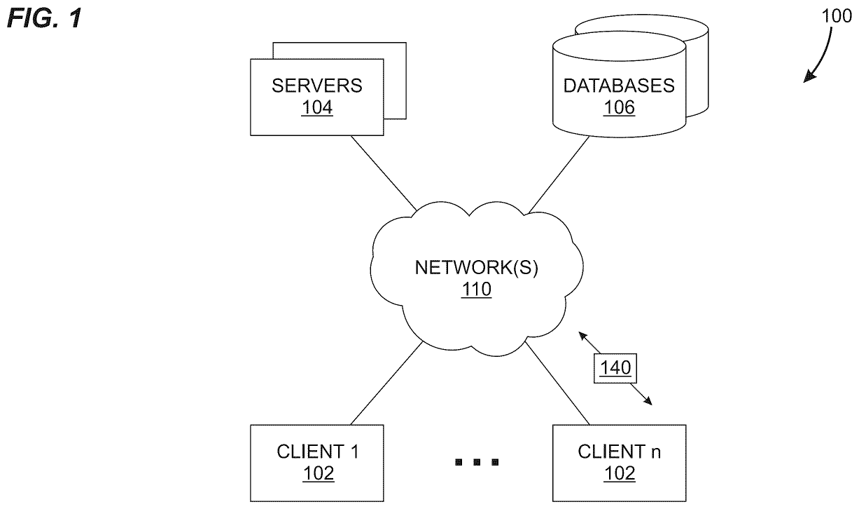

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

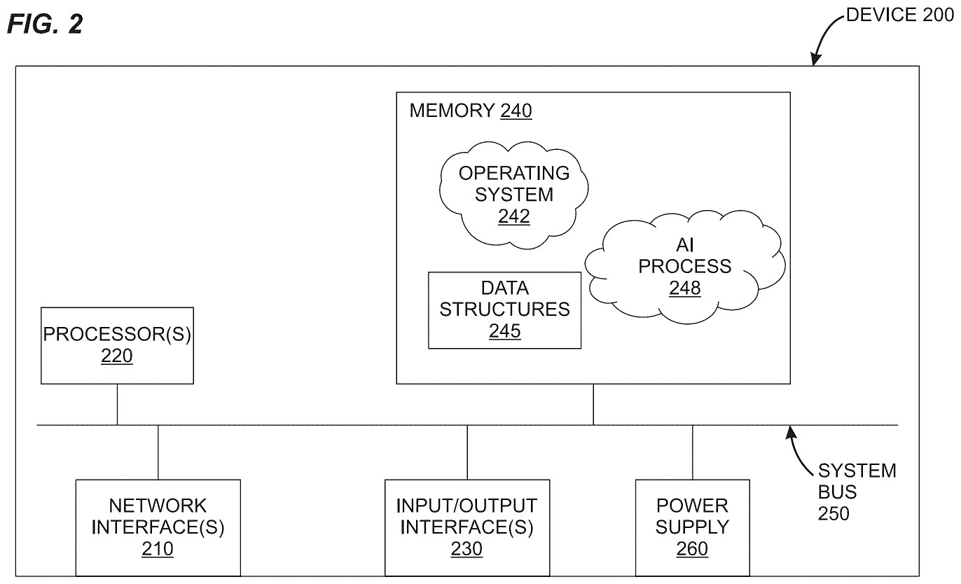

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may use one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 can use may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also use one or more generative AI/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

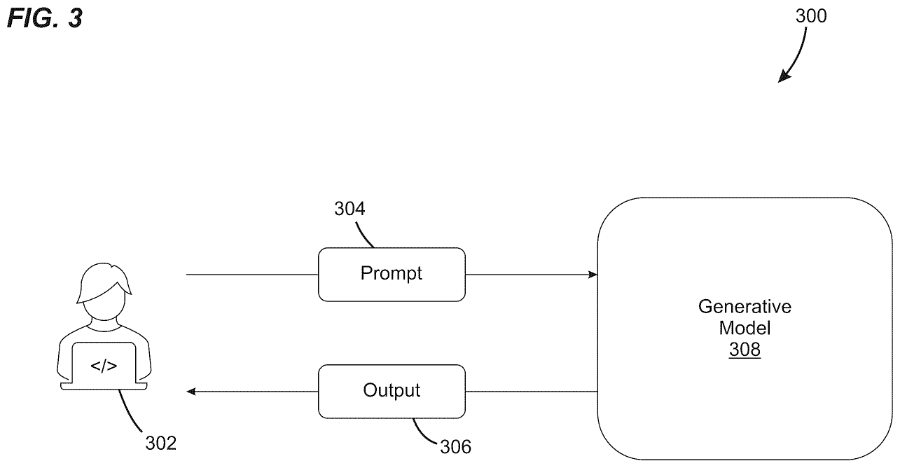

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated/synthesized image, a text response, a classification, a prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

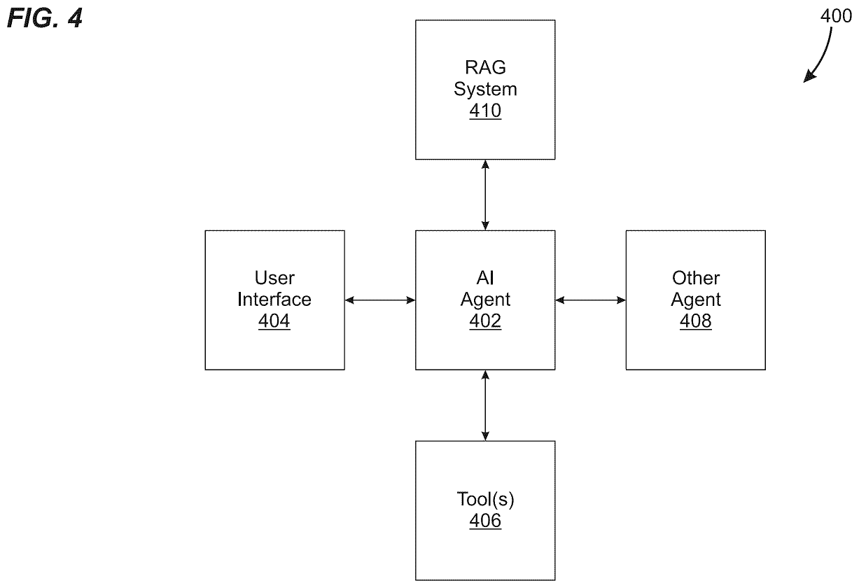

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, current AI-based agents demonstrate impressive problem-solving capabilities through multi-step reasoning and research. However, evaluating their performance of a given agent, or the set of agents as a whole, remains challenging. This is because different tasks can have very different goals and measures of success. Consequently, the evaluation criteria to evaluate the performance of a set of agents when performing a given task is manually crafted today, which is time-consuming and may not capture the specific nuances of the task.

### Automatic Agent Metric Generation

The techniques herein introduce a metrics agent that is able to generate evaluation rubrics and corresponding prompts automatically for an agentic system based on a given use case description. In some aspects, the agent uses this description to perform a semantic search using a multi-vector retriever, allowing the agent to fetch relevant examples. By leveraging {examples} and {description}, the metric agent creates comprehensive rubrics to ensure that LLM-as-a-judge evaluations are thorough, relevant, and aligned with specific task requirements.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device that executes a metrics agent obtains a description of a use case for an agentic system that comprises one or more artificial intelligence-based agents. The device retrieves example rubrics based on the description of the use case. The device generates a set of rubrics and performance metrics by inputting the description of the use case and the example rubrics to the metrics agent. The device provides the set of rubrics and performance metrics to test how well the agentic system performs for the use case.

Operationally, the techniques herein introduce the idea of automatic agentic metric generation, which can identify and extract key performance metrics and criteria given a description of the use case (or of the desired rubric) and past metrics, and thus generate a set of rubrics tailored to different tasks. This allows for comprehensive, relevant, and aligned evaluations, improving the efficiency and accuracy of LLM evaluations.

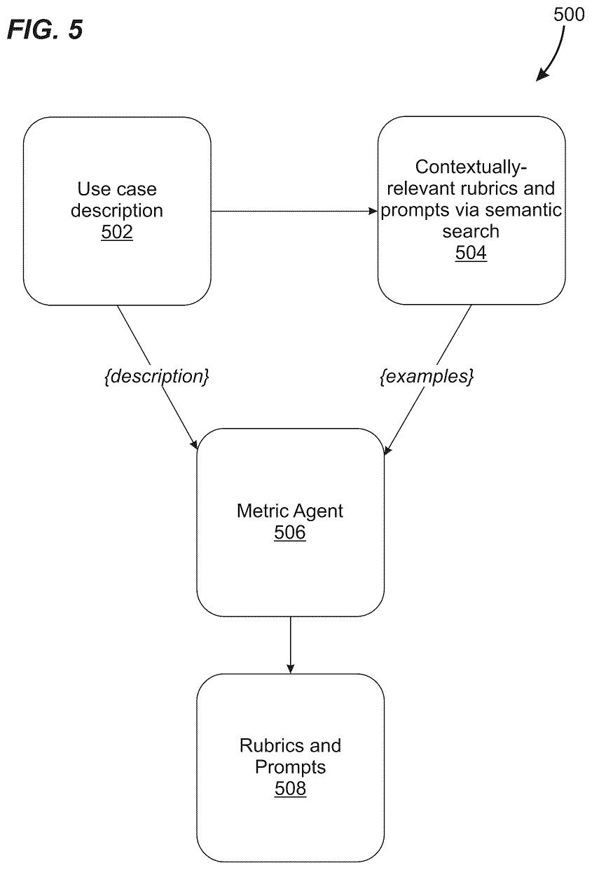

FIG. 5 illustrates an example architecture 500 for automatic agent metric generation, according to various implementations. At the core of architecture 500 is metric agent 506 (e.g., an AI agent 402 from FIG. 4) configured to generate rubrics and/or prompts for purposes of evaluating the ability of an AI agent or agentic system to perform a given task or set of tasks.

As shown, architecture 500 may operate as follows:

A database stores previous prompts along with their descriptions. Preferably, the database takes the form of a vector database for fast retrieval of contextually-relevant information 504 (e.g., rubrics and/or prompts). For instance, metric agent 506 or another agent may perform semantic search of a vector database to retrieve contextually-relevant information 504 based on a use case description 502 of the use case being evaluated. In some implementations, metric agent 506 may do so through the use of a RAG system.

Consequently, metric agent 506 may take as input both the {description} of the use case (e.g., use case description 502) and the {examples} (e.g., contextually-relevant information 504) associated with the use case retrieved from the database.

In various implementations, metric agent 506 may also use an in-context learning approach that leverages the provided examples fetched from the database as starting templates to build new rubrics and/or prompts automatically. By automatically generating evaluation rubrics and metrics, the system is able to ensure that any evaluations of an AI agent or agentic system are comprehensive, customized, and aligned with the specific requirements of the task. For instance,

More specifically, metric agent 506 may extract key performance metrics and criteria from past rubrics and prompts used as initial templates. In essence, metric agent 506 may use at least a portion of the provided examples as a starting template for the current rubric. Metric agent 506 may also leverage contextual few-shot learning to automatically retrieve relevant prompts and rubrics for any given use case from the database.

Thus, architecture 500 only requires as input the use case description 502, to automatically generate a set of rubrics and/or prompts tailored to different tasks for that use case. An LLM-as-a-judge mechanism can then use these rubrics or prompts to evaluate how well a given AI agent, agentic system, or even a standalone AI model, is able to perform a given task or set of tasks.

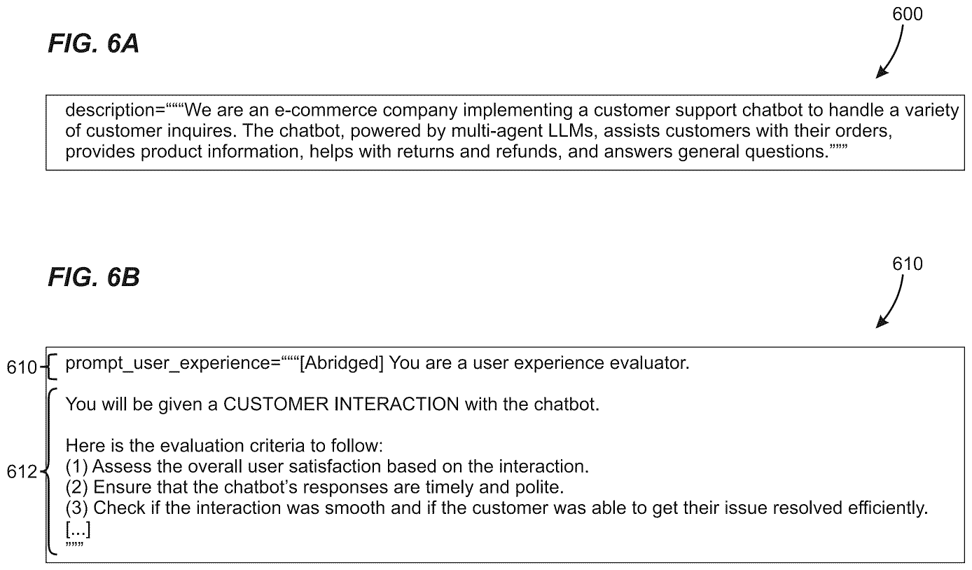

FIGS. 6A-6B illustrate an example of automatically generating rubrics to evaluate an AI agent. As shown in FIG. 6A, assume that there is a description 600 of the use case of interest. In some instances, description 600 may be user specified, such as by a human operating a user interface. In further instances, description 600 itself could be generated automatically using a generative AI model.

By way of example, description 600 may indicate that the use case is an e-commerce company implementing a chatbot for customer support. These tasks may include helping customers with their orders, providing product information, assisting customers with returns and refunds, as well as answering general questions. The chatbot itself will be powered by a multi-agent system leveraging a set of LLMs.

Given description 600, architecture 500 may generate output 610, as shown in FIG. 6B. Here, output 610 may include a prompt 612 and rubrics 614. As would be appreciated, prompt 612 and rubrics 614 could be used as input to one or more judges that take the form of one or more LLMs or other AI models that assesses the performance of the corresponding task by an agentic system, agent, AI model, or the like.

For instance, as shown, prompt 612 may indicate that the judge is to evaluate the user experience when the performing entity performs the task. To do so, rubrics 614 may indicate to the judge the criteria on which it is to assess the performing entity. For instance, rubrics 614 may indicate that the judge is to assess the overall user satisfaction based on the interaction, ensure that the chatbot's responses are timely and polite, check whether the interaction was smooth and whether the customer was able to resolve their issue efficiently.

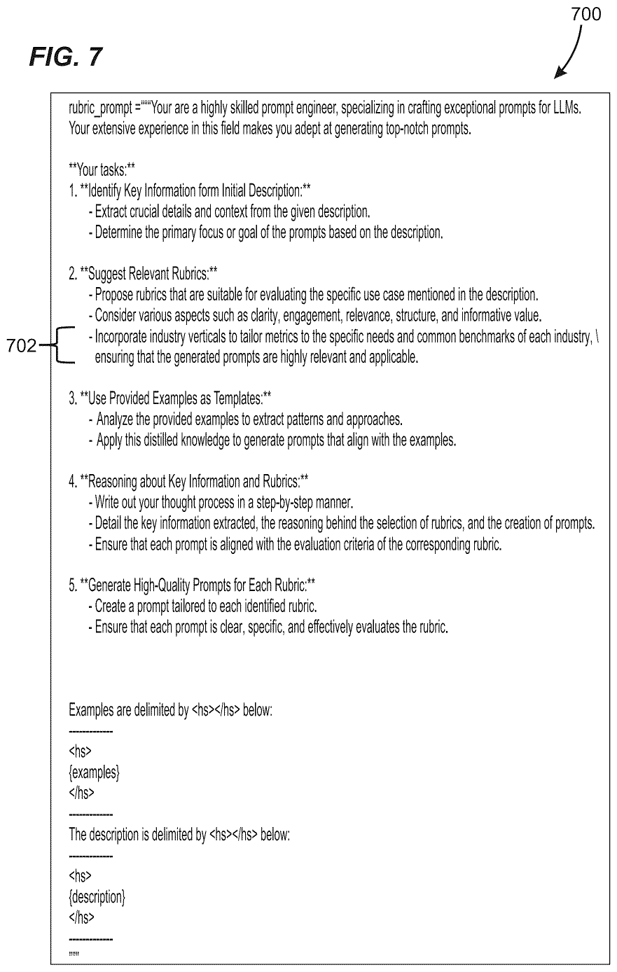

FIG. 7 illustrates an example prompt 700 for metric agent 506, in various implementations. In some instances, architecture 500 may templatize its outputs. For instance, prompt 700 may ask metric agent 506 to act as a skilled prompt engineer and to identify key information from the description of the task, suggest relevant rubrics, use any provided examples as templates, reason about the key information and rubrics, and generate high-quality prompts for each rubric.

As shown, prompt 700 may include an {example} placeholder which architecture 500 replaces with a contextually-relevant example stored in its (multi-) vector database, as shown previously in FIG. 5. Similarly, architecture 500 may replace the {description} placeholder in prompt 700 with the use case description 502 provided as input to architecture 500.

Observe the highlighted section of prompt 700 also incorporates industry verticals as a criterion for evaluating rubrics. This approach ensures that the generated prompts are tailored to the specific needs and common metrics of each industry, thereby enhancing their relevance and applicability.

In various implementations, metric agent 506 may analyze the provided examples in prompt 700 to extract relevant patterns and approaches. These examples guide the agent's response, allowing this compressed knowledge to be efficiently applied in generating new prompts.

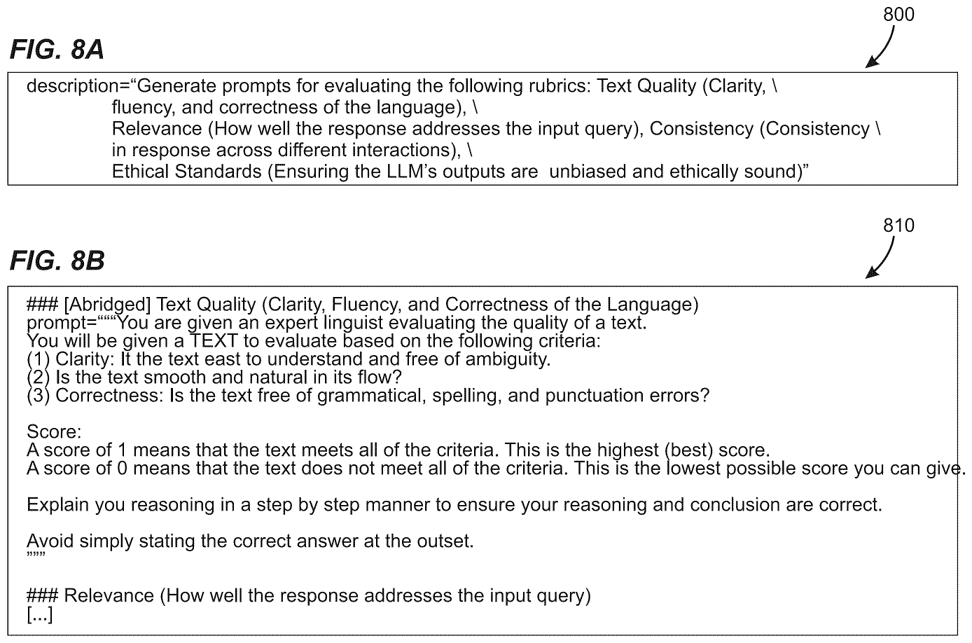

FIGS. 8A-8B illustrate an example of the automatic generation of prompts based on the description of rubrics, in various implementations. More specifically, FIG. 8A shows an example description 800 that architecture 500 may include in the prompt it sends to metric agent 506. Here, the description may indicate various rubrics such as text quality, relevance, consistency, and ethical standards for the use case.

FIG. 8B illustrates an example output 810 of metric agent 506 that includes prompts for the rubrics. For instance, as shown, output 810 may include the prompt shown for the rubric of text quality. Output 810 may also include generated prompts for the other rubrics, as well (not shown).

In summary, the techniques herein introduce a solution that allows agents to automatically generate evaluation rubrics and metrics based on a given a description of the use case or of the desired rubric, leveraging relevant examples of past rubrics and prompts. Doing so has the following benefits:
Enhanced Customization and Flexibility: By leveraging the metric agent, organizations can generate custom rubrics tailored to their unique needs, facilitating more accurate and relevant evaluations. This flexibility allows businesses to adapt the evaluation framework to various domains and specific scenarios, ensuring that the metrics used are always pertinent and effective. It also ensures that evaluations are comprehensive, relevant, and aligned with specific requirements, reducing the manual effort and expertise needed to create evaluation criteria.
Improved Evaluation Efficiency: The automatic generation of rubrics streamlines the evaluation process, enabling quicker setup and execution of assessments. This efficiency not only saves time but also accelerates the development and optimization of multi-agent solutions, leading to faster go-to-market timelines and improved overall productivity.
Value and Ramifications: The ability to automatically generate rubrics enhances the reliability and consistency of evaluations, building trust in the performance and capabilities of AI agents. This trust is crucial for organizations looking to leverage multi-agent solutions for intelligent automation, ultimately driving innovation, reducing costs, and improving operational efficiency.

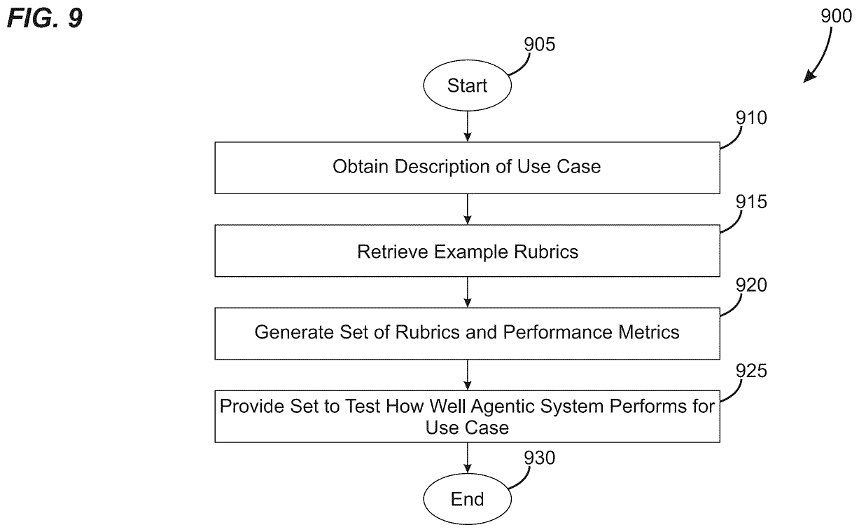

FIG. 9 illustrates an example simplified procedure for automatic agent metric generation, in accordance with one or more implementations described herein. For example, a non-generic, specifically configured device (e.g., device 200), may perform procedure 900 (e.g., a method) by executing stored instructions (e.g., AI process 248). The procedure 900 may start at step 905, and continues to step 910, where, as described in greater detail above, the device (e.g., a controller, server, etc.) may obtain, by a metrics agent, a description of a use case for an agentic system that comprises one or more artificial intelligence-based agents. In some instances, the use case indicates a particular industry.

At step 915, as detailed above, the device may retrieve example rubrics based on the description of the use case. In some implementations, the device retrieves the example rubrics from a vector database. In some instances, the example rubrics are contextually relevant to the use case.

At step 920, the device may generate a set of rubrics and performance metrics by inputting the description of the use case and the example rubrics to the metrics agent, as described in greater detail above. In various implementations, the metrics agent uses a large language model to generate the set of rubrics and performance metrics. In such cases, this step may entail a prompt for input to the large language model of the metrics agent that includes the description of the use case and the example rubrics to the metrics agent.

At step 925, as detailed above, the device may provide the set of rubrics and performance metrics to test how well the agentic system performs for the use case. In some instances, this may entail generating one or more prompts for the agentic system that include the set of rubrics and performance metrics. In one implementation, a large language model (LLM)-as-a-judge uses the set of rubrics and performance metrics to test how well the agentic system performs for the use case. By way of example, a rubric in the set of rubrics and performance metrics may relate to at least one of: text quality, relevance, consistency, or ethical standards. In a further example, a rubric in the set of rubrics and performance metrics relate to user experience.

Procedure 900 may then end at step 930.

It should be noted that while certain steps within procedure 900 may be optional as described above, the steps shown in FIG. 9 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for automatic agent metric generation, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
obtaining, by a device that executes a metrics agent, a description of a use case for an agentic system that comprises one or more artificial intelligence-based agents;
retrieving, by the device, example rubrics based on the description of the use case;
generating, by the device, a set of rubrics and performance metrics by inputting the description of the use case and the example rubrics to the metrics agent; and
providing, by the device, the set of rubrics and performance metrics to test how well the agentic system performs for the use case.

2. The method as in claim 1, wherein providing the set of rubrics and performance metrics comprises:
generating one or more prompts for the agentic system that include the set of rubrics and performance metrics.

3. The method as in claim 1, wherein the device retrieves the example rubrics from a vector database.

4. The method as in claim 1, wherein the metrics agent uses a large language model to generate the set of rubrics and performance metrics.

5. The method as in claim 4, wherein generating the set of rubrics and performance metrics comprises:
generating a prompt for input to the large language model of the metrics agent that includes the description of the use case and the example rubrics to the metrics agent.

6. The method as in claim 1, wherein the example rubrics are contextually relevant to the use case.

7. The method as in claim 1, wherein a large language model (LLM)-as-a-judge uses the set of rubrics and performance metrics to test how well the agentic system performs for the use case.

8. The method as in claim 1, wherein the use case indicates a particular industry.

9. The method as in claim 1, wherein a rubric in the set of rubrics and performance metrics relates to at least one of: text quality, relevance, consistency, or ethical standards.

10. The method as in claim 1, wherein a rubric in the set of rubrics and performance metrics relate to user experience.

11. An apparatus, comprising:
one or more network interfaces;
a processor coupled to the one or more network interfaces and configured to execute one or more processes; and
a memory configured to store a process that is executable by the processor, the process when executed configured to:
obtaining, by a metrics agent executed by the apparatus, a description of a use case for an agentic system that comprises one or more artificial intelligence-based agents;
retrieve example rubrics based on the description of the use case;
generate a set of rubrics and performance metrics by inputting the description of the use case and the example rubrics to the metrics agent; and
provide the set of rubrics and performance metrics to test how well the agentic system performs for the use case.

12. The apparatus as in claim 11, wherein the apparatus provides the set of rubrics and performance metrics by:
generating one or more prompts for the agentic system that include the set of rubrics and performance metrics.

13. The apparatus as in claim 11, wherein the apparatus retrieves the example rubrics from a vector database.

14. The apparatus as in claim 11, wherein the metrics agent uses a large language model to generate the set of rubrics and performance metrics.

15. The apparatus as in claim 14, wherein the apparatus generates the set of rubrics and performance metrics by:
generating a prompt for input to the large language model of the metrics agent that includes the description of the use case and the example rubrics to the metrics agent.

16. The apparatus as in claim 11, wherein the example rubrics are contextually relevant to the use case.

17. The apparatus as in claim 11, wherein a large language model (LLM)-as-a-judge uses the set of rubrics and performance metrics to test how well the agentic system performs for the use case.

18. The apparatus as in claim 11, wherein the use case indicates a particular industry.

19. The apparatus as in claim 11, wherein a rubric in the set of rubrics and performance metrics relates to at least one of: text quality, relevance, consistency, or ethical standards.

20. A tangible, non-transitory, computer-readable medium storing program instructions that cause a device that executes a metrics agent to execute a process comprising:
obtaining, by the device, a description of a use case for an agentic system that comprises one or more artificial intelligence-based agents;
retrieving, by the device, example rubrics based on the description of the use case;
generating, by the device, a set of rubrics and performance metrics by inputting the description of the use case and the example rubrics to the metrics agent; and
providing, by the device, the set of rubrics and performance metrics to test how well the agentic system performs for the use case.
